(19) United States
(12) Patent Application Publication
(10) Pub. No.: US 2007/0017600 A1
(43) Pub. Date: Jan. 25, 2007

(54) Tilting router table

(76) Inventor: James V. Kahl, Edgewood, MD (US)

Correspondence Address: LITMAN LAW OFFICES, LTD, PO BOX 15035, CRYSTAL CITY STATION, ARLINGTON, VA, 22215, US

(21) Appl. No.: 11/186,780

(22) Filed: Jul. 22, 2005

(51) Int. Cl. B25H 1/00; B27C 5/02; B27C 1/12

(52) U.S. Cl. 144/286.1; 144/286.5; 144/253.1; 144/253.8

(57) ABSTRACT

The tilting router table unit includes a framework having a planar top. A central opening is disposed in said planar top. A router plate is positioned in the opening and is mounted on crank rods for sliding movement within the opening. The planar top and router plate are mounted on a cabinet for tilting movement thereon. Each side of the cabinet is provided with a pivot pin and an arc-shaped assembly for facilitating the tilting movement of the router table. Once the router table is tilted, a sub table is installed over the opening for the work piece to rest upon.

### BACKGROUND OF THE INVENTION

1. Field of the Invention

The present invention generally relates to power woodworking tools. More specifically, the present invention is drawn to a tilting router table.

2. Description of the Related Art

Power routers are commonly utilized to cut woodwork pieces. Horizontal router tables are the industry standard. The horizontal table is purchased or made by the user and may be a stand-alone type or it may be attached to the side of a table saw in order to enlarge the work surface of the tabletop. Most tables have a cabinet disposed below the table top, which cabinet provides added stability and space for storage and/or dust collection apparatus. Often, woodcuts need to be made that would be less difficult if the router table were positioned at a desired angle to the horizontal. Thus, an efficient, durable, tilting router table that could easily be added to an existing table/cabinet arrangement would certainly be a welcome addition to the art.

Thus, a tilting router table solving the aforementioned problems is desired.

### SUMMARY OF THE INVENTION

The tilting router table unit of the instant invention comprises a framework having a planar top with a central opening disposed therein. A router plate is positioned in the opening and is mounted on crank rods for sliding movement within the opening. The planar top and router plate are mounted on a cabinet for tilting movement thereon. Each side of the cabinet is provided with a pivot pin and an arc-shaped assembly for facilitating the tilting movement of the router table. Once the router table is tilted, a sub table upon which the work piece rests is installed over the opening.

Accordingly, the tilting router table unit of the present invention incorporates industry standards, much improved safety, usefulness, accuracy and ease of quick changes and setups. The unit can be adapted to fit existing cabinets and can be tilted from 0 to 180 degrees. Those skilled in the art will recognize that the unit can be fabricated from various materials such as wood, metal, composites and plastics.

The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a tilting router table with the table in a first position according to the present invention.

FIG. 2 is an environmental, perspective view of a tilting router table with the table in a second position according to the present invention.

FIG. 3 is a top view of a tilting router table with the insert removed according to the present invention.

FIG. 4 is a partial, sectional, side view of a tilting router table according to the present invention.

FIG. 5 is a partial end view of a tilting router table according to the present invention.

FIG. 6 is an environmental, perspective view of a tilting router table with the table in a tilted position according to the present invention.

FIG. 7 is an environmental, perspective, bottom view of a tilting router table with the table in a tilted position according to the present invention.

FIG. 8 is an environmental, perspective view of the inside cabinet structure of a tilting router table according to the present invention.

Similar reference characters denote corresponding features consistently throughout the attached drawings.

### DETAILED DESCRIPTION OF THE PREFERRED EMBODIMENTS

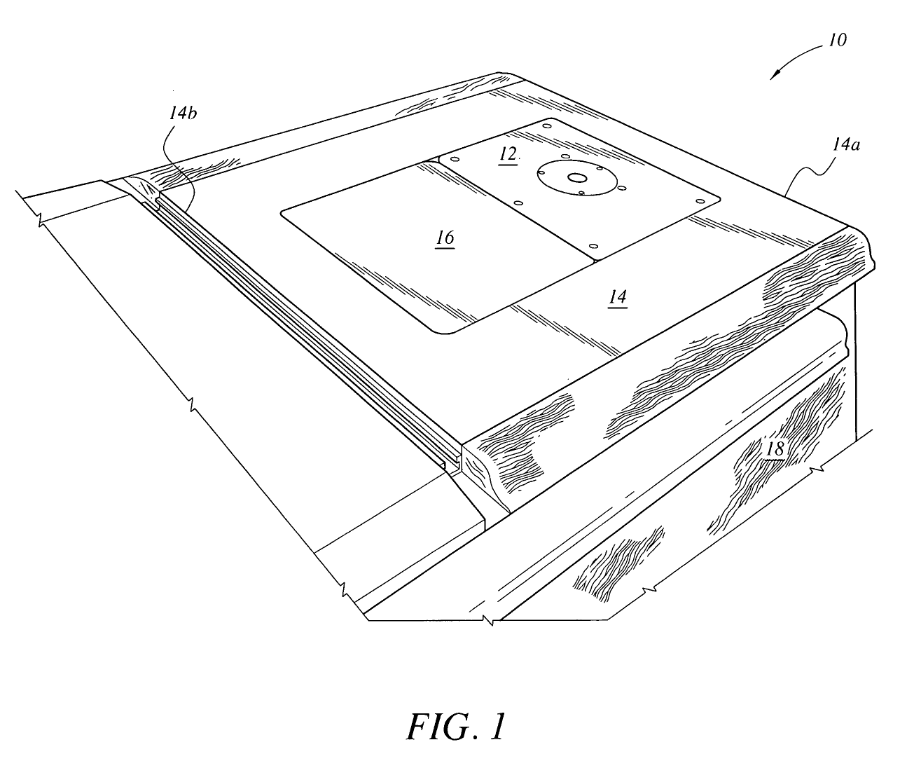

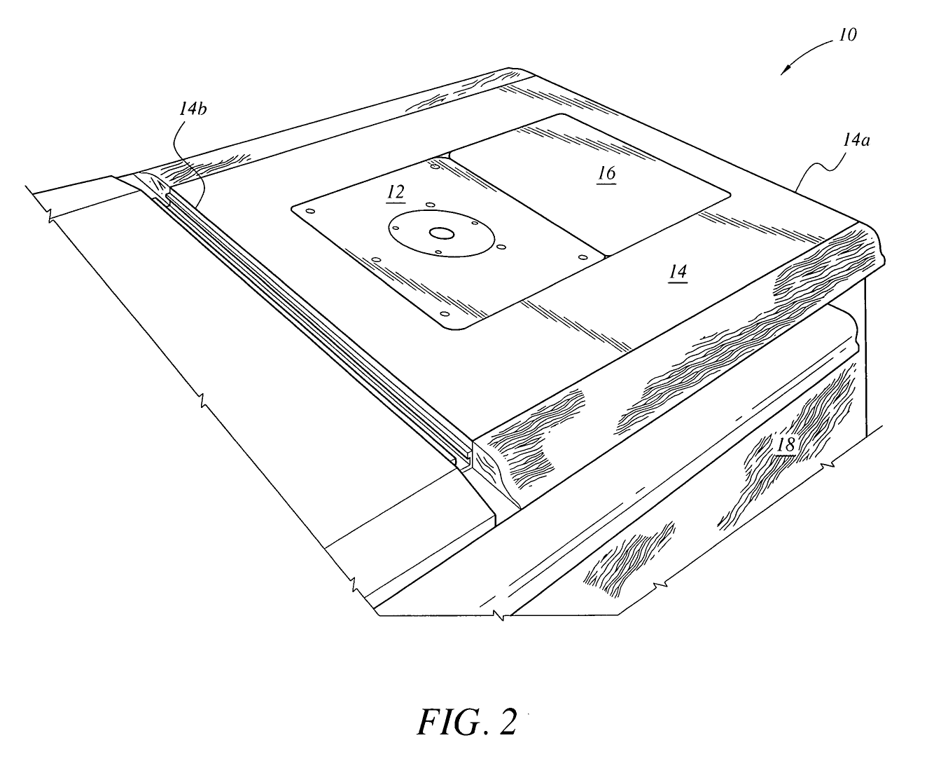

Attention is first directed to FIGS. 1 and 2 wherein the tilting router table of the present invention is generally indicated at 10. Router table 10 includes a conventional router plate assembly 12, which plate assembly is adjustably mounted in an opening formed centrally in a planar top member 14. As illustrated in FIG. 1, plate 12 is positioned adjacent the distal end 14a of planar top 14. A removable planar insert 16 is disposed to fill the open space between plate 12 and the proximate end 14b of planar top 14. As shown in FIG. 2, plate 12 the positions of plate 12 and insert 16 have been reversed. Planar top 14 is mounted on a cabinet 18. Cabinet 18 is not, per se, part of the inventive concept and can take the form of any existing or user built cabinet that may or may not incorporate a table saw. The advantages of the above described arrangement is that it permits a user to move the router plate to a position best suited for the width of the work piece to be cut. Although only one insert is shown, it should be noted that multiple inserts can be employed if desired.

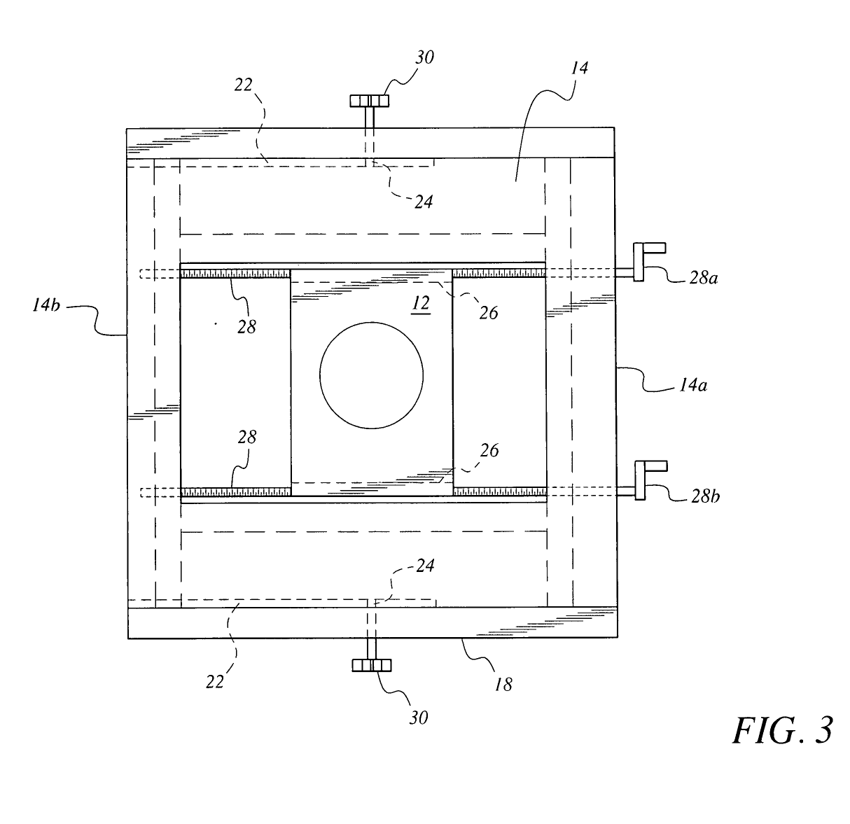

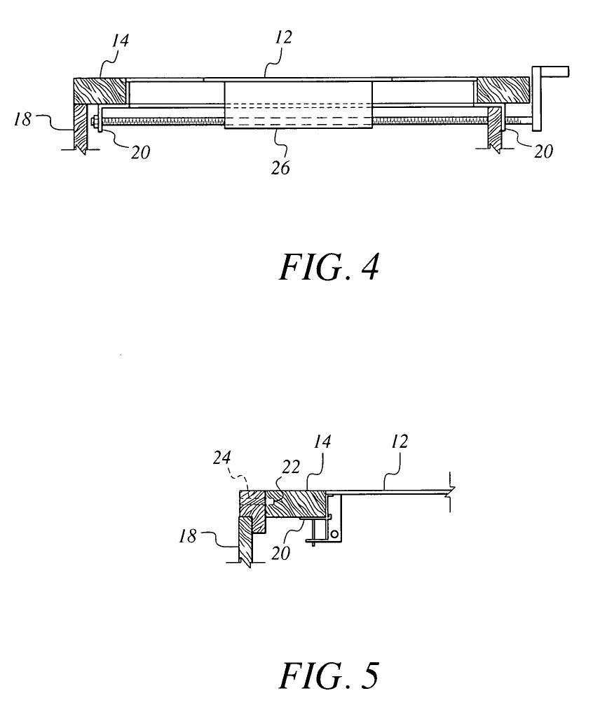

As best seen in FIGS. 3, 4 and 5, planar top 14 comprises a framework that includes support members 20 preferably fabricated from aluminum stock. Members 20 are attached to the underside of planar top 14 along perimeter and the edges of the opening. A respective slot 22 is disposed in edges along opposite sides of the planar top. Each slot is adapted to receive a respective pivot pin 24 therein. A pair of threaded crank supports 26 is mounted to the underside of router plate 12 and the supports are adapted to receive therein respective threaded crank rods 28. Each crank rod is rotatably supported in a support member 20. Each crank rod is provided with a respective handle 28a to facilitate rotation of the crank rods 28 to move the router plate 12 to a desired position within the opening of planar top 14. Although two manually operated crank handles are illustrated, it is recognized that a conventional link belt assembly could connect the rods so that only one handle would have to be manipulated. It is also contemplated that a small electric motor could be utilized to perform the tilting function. A tightening mechanism (preferably screw-type) 30 is disposed at each pivot pin for reasons as will be explained below.

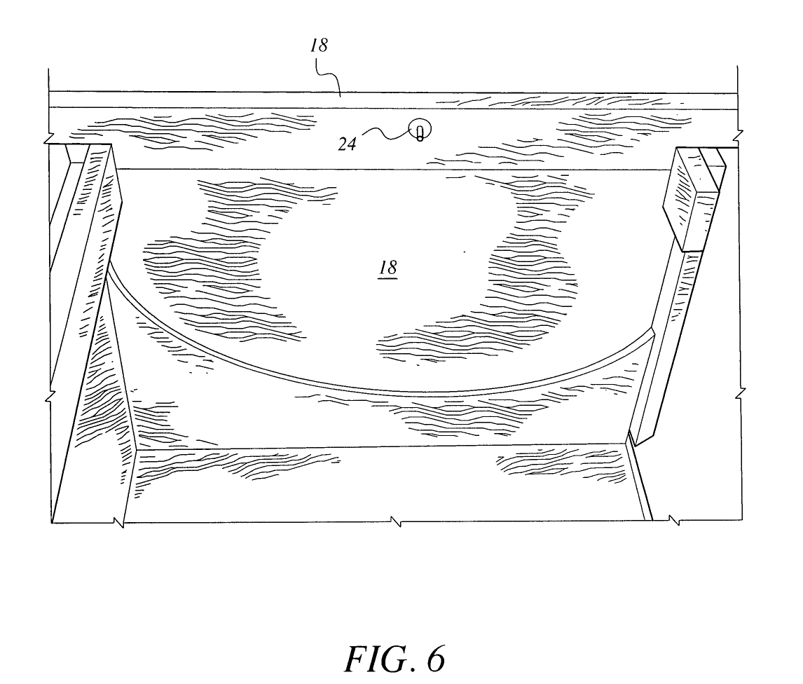

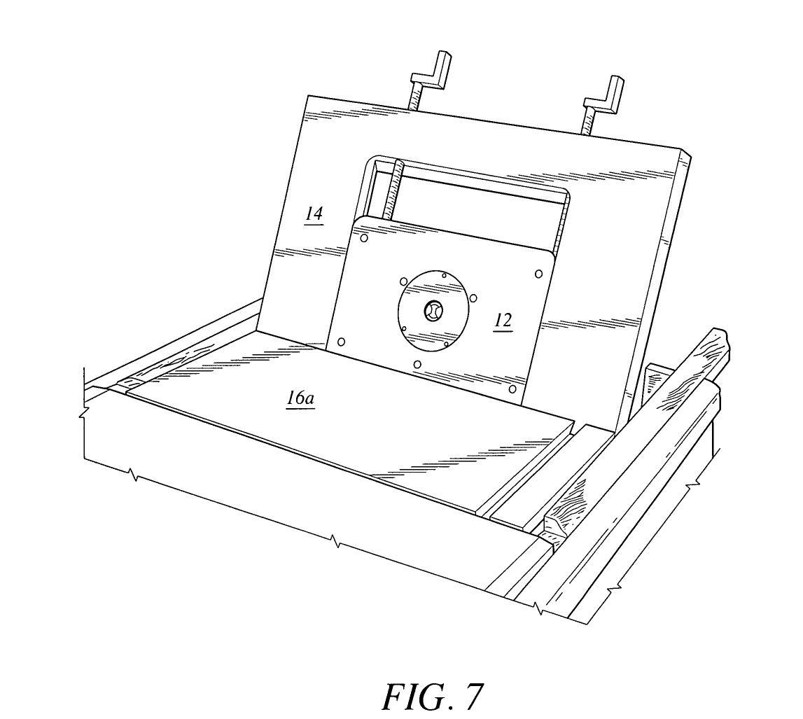

Modification of the inside surface on each side of the cabinet is required for efficient and proper tilting of the table. FIG. 6 is illustrative of the required modification. An arc-shaped support member 32 is attached to the inner side surface of cabinet 18. An identical support member (not shown) is attached to the opposite inner side cabinet surface. When it is desired to pivot the planar top, insert 16 is removed and the router plate is moved to a position adjacent the proximate end of the planar top. Planar top is then pulled in a direction toward its distal end. The planar top can now be pivoted via slots 22 and pivot pins 24 to a desired tilted as shown in FIG. 7. The proximate edge of the planar top will be disposed in the arc-shaped support 32. Small flip-up stops may be strategically positioned at various points along the support 32 to enable the planar top to be quickly pivoted to the most often used angles, i.e., 30°, 45°, and 60°. A sub table 16a is installed to provide support for the tilted planar top and a planar surface for the work piece. Additionally, mechanism 30 is employed to tighten the pivot pin assembly against the cabinet to secure the pivoted table in place.

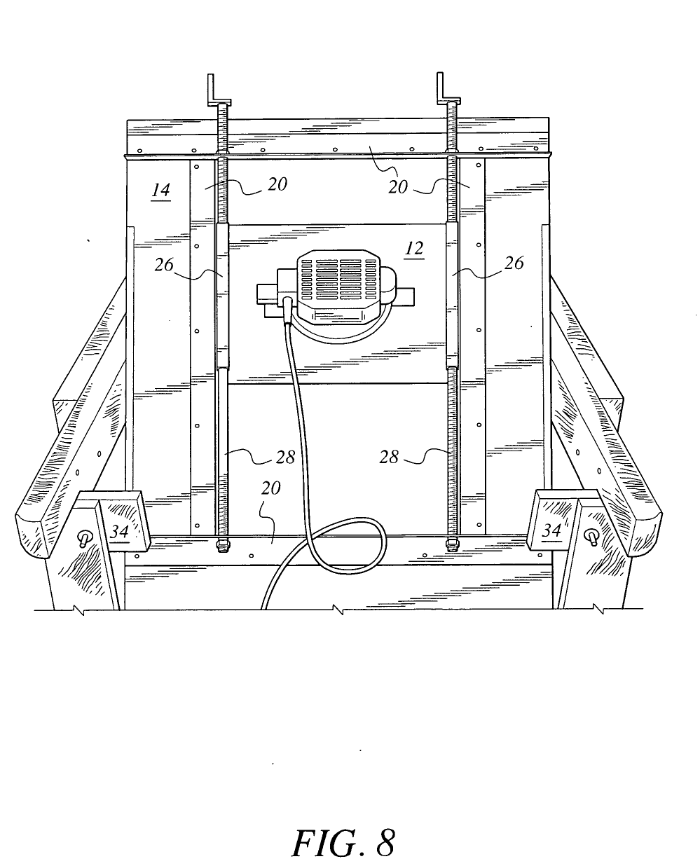

FIG. 8 shows the planar top pivoted approximately 180 degrees. Stops 34 are attached to the cabinet to prevent rotation greater than 180 degrees. Bolts, or the like (not shown) are arranged to lock the top to the cabinet when the top is in a horizontal position.

It is to be understood that the present invention is not limited to the embodiments described above, but encompasses any and all embodiments within the scope of the following claims.

I claim:

1. A tilting router table, comprising:
a cabinet, said cabinet having an open upper end and side walls with oppositely facing inner surfaces;
a planar top member pivotally mounted on said cabinet, said planar top member having a proximate end, a distal end and two opposite edges;
a centrally positioned opening disposed in said planar top member;
a router plate assembly disposed in said centrally positioned opening; and
a removable planar insert positioned in said centrally positioned opening.

2. The tilting router table according to claim 1, wherein a respective slot is formed in each of said two opposite edges of said planar top member.

3. The tilting router table according to claim 1, further including:
a respective pivot pin mounted in each oppositely facing inner surface of said side walls; and
a respective slot formed in each of said two opposite edges of said planar top member, wherein each slot receives a respective pivot pin.

4. The tilting router table according to claim 1, further including:
a respective pivot pin mounted in each inner surface of said sidewalls;
a respective slot formed in each of said two opposite edges of said planar top member, wherein each slot receives a respective pivot pin; and
a respective arc-shaped support member mounted to each oppositely facing inner surface of said sidewalls.

5. The tilting router table according to claim 1, wherein said router plate assembly has an underside and further including:
a pair of threaded crank rod supports mounted to said underside;
a pair of threaded crank rods mounted to said planar top member and threadedly engaged with said pair of crank rod supports, whereby said router plate assembly is adjustably disposed in said centrally positioned opening.

6. The tilting router table according to claim 5, wherein each threaded crank rod has an end extending beyond the distal end of said planar top member and including:
a handle attached to each end of said crank rod.

7. A tilting router table, comprising:
a cabinet, said cabinet having an open upper end and side walls with oppositely facing inner surfaces;
a planar top member pivotally mounted on said cabinet, said planar top member having a proximate end, a distal end and two opposite edges;
a respective pivot pin mounted in each inner surface of said sidewalls;
a respective slot formed in each of said two opposite edges of said planar top member, wherein each slot receives a respective pivot pin;
a respective arc-shaped support member mounted to each oppositely facing inner surface of said sidewalls;
a centrally positioned opening disposed in said planar top member;
a router plate assembly adjustably disposed in said centrally positioned opening; and
a removable planar insert positioned in said centrally positioned opening.

8. The tilting router table according to claim 7, wherein said router plate assembly has an underside and further including:
a pair of threaded crank rod supports mounted to said underside;
a pair of threaded crank rods mounted to said planar top member and threadedly engaged with said pair of crank rod supports, whereby said router plate assembly is adjustably disposed in said centrally positioned opening.

9. The tilting router table according to claim 8, further including:
a tightening mechanism attached to each pivot pin.

10. The tilting router table according to claim 8, wherein each threaded crank rod has an end extending beyond the distal end of said planar top member, including a handle attached to each end of said crank rod.

11. A tilting router table, comprising:
a planar top member, said planar top member having a proximate end, a distal end and two opposite edges;
a centrally positioned opening disposed in said planar top member;
a router plate assembly disposed in said centrally positioned opening; and
a removable planar insert positioned in said centrally positioned opening.

12. The tilting router table according to claim 1 1, wherein said router plate assembly has an underside, the table further including:
a pair of threaded crank rod supports mounted to said underside;
a pair of threaded crank rods mounted to said planar top member and threadedly engaged with said pair of crank rod supports, whereby said router plate assembly is adjustably disposed in said centrally positioned opening.

13. The tilting router table according to claim 1 2, wherein each threaded crank rod has an end extending beyond the distal end of said planar top member, each of said rods including a handle attached to each end of said crank rod.
